(19) United States
(12) Patent Application Publication
(10) Pub. No.: US 2023/0044217 A1
(43) Pub. Date: Feb. 9, 2023

(54) TEXT INPUT APPARATUS FOR IMPROVING SPEECH RECOGNITION PERFORMANCE AND METHOD USING THE SAME

(71) Applicant: Electronics and Telecommunications Research Institute, Daejeon (KR)

(72) Inventors: Dong-Hyun KIM, Daejeon (KR); Sang-Hun KIM, Daejeon (KR)

(73) Assignee: Electronics and Telecommunications Research Institute, Daejeon (KR)

(21) Appl. No.: 17/517,211

(22) Filed: Nov. 2, 2021

(30) Foreign Application Priority Data
Aug. 4, 2021 (KR) 10-2021-0102437

(51) Int. Cl. G06F 3/0488; G06F 3/16; G10L 15/22; G10L 15/26

(52) U.S. Cl. CPC G06F 3/04883; G06F 3/167; G10L 15/22; G10L 15/26

(57) ABSTRACT

Disclosed herein are a text input apparatus for improving speech recognition performance and a method using the same. The text input method may include arranging all characters on an input screen including multiple key input areas in consideration of usage frequency of respective characters and usage association between the characters, setting input schemes for all the characters in consideration of positions of the multiple key input areas and positions of characters arranged in each key input area, and inputting characters through touch-based input corresponding to the input schemes.

### CROSS REFERENCE TO RELATED APPLICATION

This application claims the benefit of Korean Patent Application No. 10-2021-0102437, filed Aug. 4, 2021, which is hereby incorporated by reference in its entirety into this application.

### BACKGROUND OF THE INVENTION

### 1. Technical Field

The present invention relates generally to touch-screen-based text input technology for improving speech recognition performance, and more particularly to technology for conveniently inputting text so as to correct errors in speech recognition in a terminal supporting a touch-screen input scheme, such as a smartphone.

### 2. Description of the Related Art

A QWERTY scheme, which is used as a typical mobile text input method, is a method which complies with an input scheme based on an English (Roman) keyboard on a computer without change. Since such a QWERTY scheme uses a basic keyboard input method without change, a user must touch a keypad a number of times identical to the number of English alphabet letters, the keypad is partitioned into a large number of input areas and key sizes are small, thus being apt to cause input errors.

As another mobile text input method, there is a method for assigning three English alphabet letters to each of 3×3 key input areas of a mobile device, sequentially arranging the keys, and inputting the corresponding alphabet letter through a touch, a double-touch, or a triple-touch. This method is advantageous in that the positions of alphabet letters can be easily detected owing to sequential key arrangement, but it is disadvantageous in that the average number of input touches per letter is increased due to the implementation of double touch and triple touch. Also, because a touch speed must be controlled in order to successively input letters occupying the same key area, input errors can easily occur.

As a further mobile text input method, there is a method using a flick gesture input. Here, a flick operation may be a method in which, when a finger is quickly moved in a specific direction like a sweep operation after one point on a touch screen is pressed with the finger, a list or an element is scrolled in the corresponding direction. Therefore, when one of English alphabet letters assigned to each of 3×3 key input areas on the mobile terminal is flicked in a specific direction, a subsequent letter or a previous letter may be selected while the letters are scrolled on the screen. However, until the user selects a letter after scrolled letters are displayed in the corresponding key input area, a time delay is present, so a user who desires to quickly and successively to input text may feel inconvenience.

As vet another mobile text input method, there is a method using a drag in 3×3 key input areas of a mobile terminal. For example, when a key area in which a drag starts is identical to a key area in which the drag ends in the state in which three English alphabet letters are assigned to each of 3×3 key input areas, the first alphabet letter in the corresponding key area is input. Further, an N-th alphabet letter in a key input area in which a drag ends after the corresponding key area is dragged by the number (N) of key input areas passing in a horizontal or vertical direction through the drag is input. That is, this method is a scheme in which a double touch or a triple touch in the basic text input method is replaced with a drag, but it is disadvantageous in that the number of movement areas corresponding to the start and end of each drag must be taken into consideration each time for the same input, and it is problematic in that the number of movement areas to be dragged is rapidly increased in order to successively input a third or fourth letter in the corresponding key input area.

### PRIOR ART DOCUMENTS

### Patent Documents

(Patent Document 1) Korean Patent Application Publication No. 10-2011-0066414, Date of Publication: Jun. 17, 2011 (entitled: Method for inputting English Text by Using Touch Screen)

### SUMMARY OF THE INVENTION

Accordingly, the present invention has been made keeping in mind the above problems occurring in the prior art, and an object of the present invention is to provide a method for allowing a user to effectively and quickly input principal characters, the recognition rate of which is to be increased, using a touch screen in order to improve the performance of a speech recognizer in a mobile terminal.

Another object of the present invention is to present a scheme for enabling characters to be efficiently input using a small number of input keys in order to reduce input error that occurs due to the small size of key input areas of a mobile terminal.

A further object of the present invention is to provide a text input method, which can mitigate fatigue while improving the usefulness of the text input method by providing an intuitive input method in which the number of operations of inputting text or the size of a motion required for text input is reduced.

Yet another object of the present invention is to provide a text input method in a mobile terminal, which enables all characters to be input using only a touch is and a drag with one hand and allows voice recording to be performed immediately after the input of characters is terminated.

In accordance with an aspect of the present invention to accomplish the above objects, there is provided a text input method, including arranging all characters on an input screen including multiple key input areas in consideration of usage frequency of respective characters and usage association between the characters; setting input schemes for all the characters in consideration of positions of the multiple key input areas and positions of characters arranged in each key input area; and inputting characters through touch-based input corresponding to the input schemes.

The multiple key input areas may be 3×3 or 3×4 key input areas, and a function key is included in a central portion of the input screen.

Each of the input schemes may be set to correspond to any one of a touch, a double touch, a drag, and a hold.

The function key may provide multiple functions including spacing, input of a period, and voice recording, depending on the input schemes.

All the characters may be classified into a low-frequency character, a middle-frequency character, and a high-frequency character depending on the usage frequency, wherein the high-frequency character is input through a touch, the middle-frequency character is input through any one of a double touch and a drag to outside of a key input area, and the low-frequency character is input through a drag to a boundary of a central key input area, among the multiple key input areas.

The high-frequency character may be displayed on the input screen to appear larger than the middle-frequency character and the low-frequency character.

Arrows for guiding respective input schemes for all the characters depending on the corresponding input schemes may be displayed together with the characters.

Inputting the characters may be configured to provide a continuous drag mode in which successively selected multiple characters are input in consideration of a start position of a drag, an end position of a drag, a point at which a direction of a drag changes, and a drag and hold point.

The text input method may further include, when voice recording is selected using the function key, providing a voice recording function of recording voice corresponding to a word including input characters.

Here, the text input method may further include arranging special characters, the usage frequency of which is equal to or greater than a preset level, in the remaining space of the input screen, other than the positions at which all the characters are arranged.

The text input method may further include providing the word including the input characters and voice data, corresponding to the word, recorded through the voice recording function to a speech recognition system.

In accordance with another aspect of the present invention to accomplish the above objects, there is provided a text input apparatus, including a processor for arranging all characters on an input screen including multiple key input areas in consideration of usage frequency of respective characters and usage association between the characters, setting input schemes for all the characters in consideration of positions of the multiple key input areas and positions of characters arranged in each key input area, and inputting characters through touch-based input corresponding to the input schemes; and a memory for storing respective input schemes that are set for all the characters.

The multiple key input areas may be 3×3 or 3×4 key input areas, and a function key is included in a central portion of the input screen.

Each of the input schemes may be set to correspond to any one of a touch, a double touch, a drag, and a hold.

The function key may provide multiple functions including spacing, input of a period, and voice recording, depending on the input schemes.

All the characters may be classified into a low-frequency character, a middle-frequency character, and a high-frequency character depending on the usage frequency, wherein the high-frequency character is input through a touch, the middle-frequency character is input through any one of a double touch and a drag to outside of a to key input area, and the low-frequency character is input through a drag to a boundary of a central key input area, among the multiple key input areas.

The high-frequency character may be displayed on the input screen to appear larger than the middle-frequency character and the low-frequency character.

Arrows for guiding respective input schemes for all the characters is depending on the corresponding input schemes may be displayed together with the characters.

The processor may be configured to provide a continuous drag mode in which successively selected multiple characters are input in consideration of a start position of a drag, an end position of a drag, a point at which a direction of a drag changes, and a drag and hold point.

The processor may be configured to, when voice recording is selected using the function key, provide a voice recording function of recording voice corresponding to a word including input characters.

Here, the processor may be configured to arrange special characters, the usage frequency of which is equal to or greater than a preset level, in the remaining space of the input screen, other than the positions at which all the characters are arranged.

The processor may be configured to provide the word including the input characters and voice data, corresponding to the word, recorded through the voice recording function to a speech recognition system.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is an operation flowchart illustrating a text input method for improving speech recognition performance according to an embodiment of the present invention;

FIG. 2 is a diagram illustrating an example of a 3×3 input screen according to the present invention;

FIG. 3 is a diagram illustrating examples of characters that can be input through a touch on the 3×3 input screen illustrated in FIG. 2;

FIG. 4 is a diagram illustrating examples of characters that can be input through a double touch or a drag on the 3×3 input screen illustrated in FIG. 2;

FIG. 5 is a diagram illustrating examples of characters that can be input through a drag in the direction from a central key area to outer key areas on the 3×3 input screen illustrated in FIG. 2;

FIG. 6 is a diagram illustrating examples of characters that can be input through a drag in the direction from outer key areas to a central key area on the 3×3 input screen illustrated in FIG. 2;

FIG. 7 is a diagram illustrating an example in which additional function keys are arranged on the 3×3 input screen according to the present invention;

FIG. 8 is a diagram illustrating an example of drag areas for respective characters on the 3×3 input screen in a continuous drag mode according to the present invention;

FIGS. 9 and 10 are diagrams illustrating examples in which a word is input on the 3×3 input screen using a continuous drag mode according to the present invention;

FIG. 11 is a diagram illustrating another example of the 3×3 input screen according to the present invention;

FIG. 12 is a diagram illustrating an example of a 3×4 input screen according to the present invention;

FIG. 13 is a diagram illustrating an example of drag areas for respective characters on the 3×4 input screen in a continuous drag mode according to the present invention;

FIGS. 14 and 15 are diagrams illustrating examples in which a word is input on the 3×4 input screen using a continuous drag mode according to the present invention;

FIG. 16 is an operation flowchart illustrating a text input process according to an embodiment of the present invention; and

FIG. 17 is a diagram illustrating a text input apparatus for improving speech recognition performance according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

Recently, with the improvement of speech recognition, speech recognition is sometimes used in place of text input on a mobile device, but text input still remains an important function of the mobile device. Also, in order to improve the recognition rate of proper nouns that are not frequently used or words that are falsely recognized, a text input function may be used as a method for preliminary learning and post-correction.

That is, speech recognition technology using a mobile terminal requires improvement of recognition performance for words considered by a user to be important. However, the recognition rate for words that are less frequently used in daily lite, such as proper nouns or the name of a specific person, is inevitably low. In order to improve this, text input may be utilized to input in advance words for which it is determined that improvement of recognition performance is required for each user, or to correct words corresponding to the result of false recognition.

In this way, text input on a mobile device continues to play an important role, and more accurately and quickly inputting a short sentence or words is considered important when inputting text.

However, since a language such as English has 26 alphabet letters, it is inconvenient to input respective characters on a small input screen of a device, such as a mobile device, using a QWERTY method because partitioned key input areas are too small to quickly and precisely input characters. English is the most widely used language in the world, and there are many cases where English is used as a foreign language even if English is not a native language, and thus a method for quickly and precisely inputting English characters is essentially required.

In order to overcome this inconvenience and meet the requirement, a method for assigning three characters to each of 3×3 key input areas and inputting a desired character is used. However, there are disadvantages in that characters are input through several touch operations, so that the number of touches per character increases, and in that false input may easily occur when different characters in the same key area are successively input.

In order to overcome the disadvantages, the present invention is intended to present a new text input method which classifies 26 English alphabet letters depending on the usage frequency thereof to implement convenient character input on a mobile terminal having a size-limited touch screen, and sets respective input schemes for classified characters, thereby enabling more efficient input of characters.

By means of this method, text input can be quickly and easily performed using a structure of 3×3 key areas, which is the most convenient structure for use with one hand, and a function of recording voice corresponding to text input can be provided together with a text input function, thus improving the success rate of mobile speech recognition.

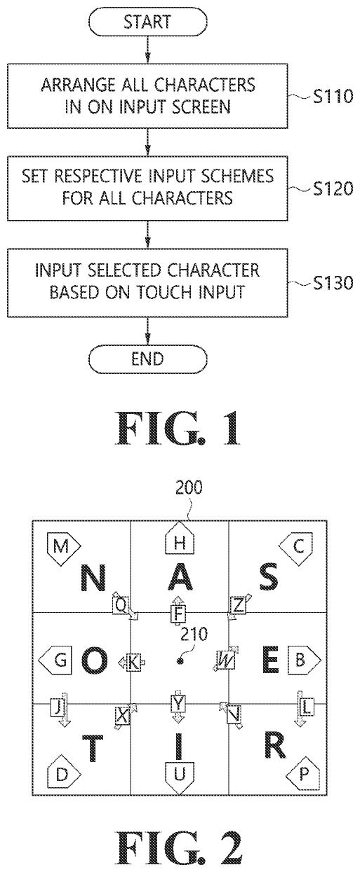

FIG. 1 is an operation flowchart illustrating a text input method for improving speech recognition performance according to an embodiment of the present invention.

Referring to FIG. 1, in the text input method for improving speech recognition performance according to an embodiment of the present invention, all characters are arranged on an input screen composed of multiple key input areas in consideration of usage frequency of the characters and usage association between the characters at step S110.

Here, the multiple key input areas may be 3×3 or 3×4 key input areas, and a function key may be included in a central portion of the input screen.

For example, multiple key input areas corresponding to 3×3 or 3×4 key to input areas may include a total of 9 or 12 touch areas. Since the input screen composed of multiple key input areas in this way has top, middle, and bottom positions and left, middle, and right positions, as in the case of numeric key input, the input screen is advantageous in that the positions of input keys can be memorized relatively easily, and text can be easily input by a user using only one hand.

In this case, all characters may be classified into low-frequency characters, middle-frequency characters, and high-frequency characters depending on the usage frequency of the characters.

For example, by utilizing the ranking of English character frequencies investigated and published by Oxford University Press, the vowels E, A, I, and O and the consonants N, S, and R, which have the highest usage frequency, are classified as high-frequency characters, the vowel U and the consonants M, H, C, G, B, P, and D, which have the next highest usage frequency, may be classified as middle-frequency characters, and the remaining characters may be classified as low-frequency characters.

Here, the high-frequency characters may be displayed on the input screen so as to appear larger than the middle-frequency characters and the low-frequency characters.

For example, referring to FIG. 2, an input screen 200 may be composed of multiple key input areas corresponding to 3×3 key input areas, and may include a function key 210 in a central portion thereof Referring to the input screen 200, the vowels ‘E’, ‘A’, ‘I’, and ‘O’ and the consonants ‘N’, ‘S’, ‘Y’, and ‘R’, which are the high-frequency characters, are displayed to appear larger than the remaining characters, that is, the middle-frequency characters and the low-frequency characters, thus allowing the user to quickly detect the positions of frequently used characters.

Here, all characters are arranged such that respective characters associated with each other based on character images are arranged together, thus allowing the user to easily memorize the positions of the characters.

For example, as illustrated in FIG. 2, eight high-frequency characters are arranged closer to the central portion than the remaining characters. Among the eight high-frequency characters, vowels are assigned to central axes, thus increasing the convenience of the user.

Thereafter, the middle-frequency characters are arranged such that respective characters having image association (i.e., appearing similar to each other) are assigned to the same key area. That is, as illustrated in FIG. 2, ‘M’ may be arranged together with ‘N’ in the same key area, ‘H’ may be arranged together with ‘A’ in the same key area, ‘C’ may be arranged together with ‘S’ in the same key area, ‘G’ may be arranged together with ‘O’ in the same key area, ‘B’ may be arranged together with ‘E’ in the same key area, ‘P’ may be arranged together with ‘R’ in the same key area, ‘U’ may be arranged together with ‘I’ in the same key area, and ‘D’ may be arranged together with ‘T’ in the same key area.

Thereafter, the remaining characters, that is, the low-frequency characters, may be arranged. In detail, ‘J’ and ‘L’ having a symmetric character image may be arranged on boundary lines such that they are dragged in a downward direction from a middle-left key area and dragged in a downward direction from a middle-right key area, respectively, thus allowing the user to easily memorize the positions of the characters through image symmetry.

In this case, in the central portion of the input screen 200, the function key 210 may be displayed, which may correspond to a key for providing various functions depending on the input scheme thereof.

As will be described in detail later, the function key 210 may provide functions, such as spacing, the input of a period, and voice recording, depending on the input scheme.

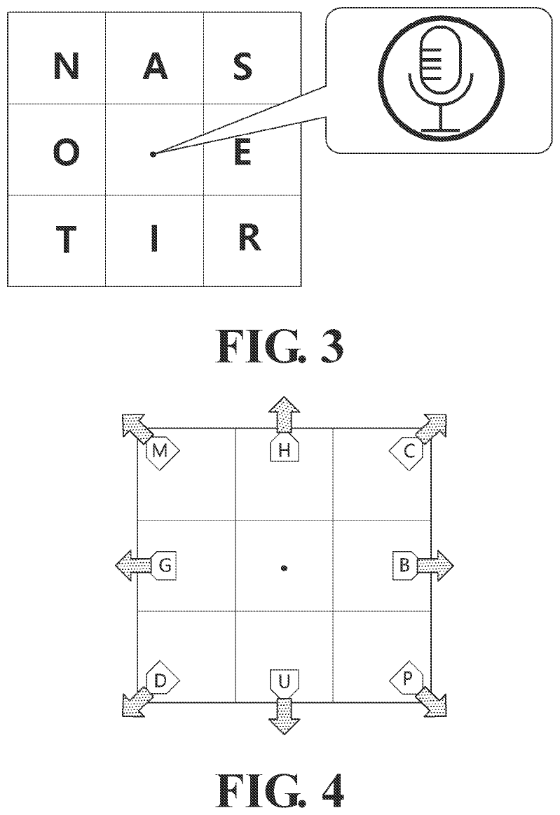

For example, when the function key ‘●’ illustrated in FIG. 3 is touched and held for a predetermined time (long-pressed), an indication that a voice recording function is being activated may be displayed together with a popup image. When such a touch and hold action is terminated, the popup image may disappear simultaneously with the termination of voice recording.

In another example, a word-spacing function corresponding to a frequently used ‘space’ key may be assigned to the function key 210.

The present invention may match a word, input by the user via the input screen 200, with the user's voice by providing the voice recording function, thus improving a speech recognition function.

The above-described character arrangement is very important from the standpoint of user convenience. Therefore, the arrangement of characters in the present invention is not limited to the examples illustrated in the drawings, and can be changed in various ways.

Next, the text input method for improving speech recognition performance according to the embodiment of the present invention sets respective input schemes for all characters in consideration of the positions of the multiple key input areas and the positions of characters arranged in each key input area at step S120.

Here, each of the input schemes may be set to correspond to any one of a touch, a double touch, a drag, and a hold.

In this case, since English is a language composed of 26 alphabet letters, 9 or 12 key input areas corresponding to a 3×3 or 3×4 input screen may be insufficient to display all characters. Therefore, the present invention is intended to propose a method which enables input of 26 alphabet letters by combining the input schemes, such as a touch, a double touch, a drag, and a hold.

In this case, because a touch scheme is slightly faster than a drag scheme, the input schemes may be set such that the high-frequency characters are input using a touch scheme, the middle-frequency characters are input using an outward drag scheme that is relatively clearly identified, and the low-frequency characters are input using an inward drag scheme.

In this way, the present invention may distinguish characters depending on the usage frequency thereof, and may arrange the characters in respective key input areas depending on the usage frequency.

Here, drag input in nine touch areas corresponding to a 3×3 input screen may be performed such that a corresponding character is input through a drag action in the direction from inside the corresponding key input area to the outside thereof while crossing the boundary of the key input area in order to minimize the amount of motion required for drag input. Because each key area basically has a rectangular shape, the boundary of the key input area may be a top/bottom (vertical) boundary or a left/right (horizontal) boundary, or may be a diagonal boundary, that is, a boundary between corners.

All of 26 alphabet letters may be input using a scheme for assigning meanings depending on a drag direction.

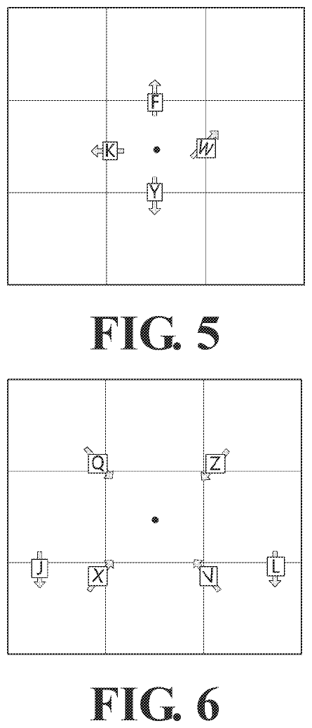

For example, ‘E, A, R, I, O, T, N, and S’, which are the high-frequency characters illustrated in FIG, 3, may be input through one touch, ‘C, U, D, P, M, H, G, and B’, which are the middle-frequency characters illustrated in FIG. 4, may be input through a drag or a double touch, and ‘F, Y, W, K, V, X, Z, Q, J, and L’, which are the low-frequency characters illustrated in FIG. 5 or 6, may be input through a drag in a vertical, horizontal, or diagonal direction.

In this case, describing input of characters through a drag in detail, ‘F’ illustrated in FIG. 5 may be input through an upward drag, ‘Y’ may be input through a downward drag, ‘K’ may be input through a leftward drag, and ‘W’ may be input through a rightward drag. Further, ‘Q’ illustrated in FIG. 6 may be input through a drag in the direction from an outer key area in a top-left portion to a central key area, ‘Z’ may be input through a drag in the direction from an outer key area in a top-right portion to the central key area, ‘X’ may be input through a drag in the direction from an outer key area in a bottom-left portion to the central key area, ‘V’ may be input through a drag in the direction from an outer key area in a bottom-right portion to the central key area, ‘J’ may be input through a drag in a downward direction from an outer key area in a middle-left portion, and ‘L’ may be input through a drag in a downward direction from an outer key area in a middle-right portion.

In this case, as illustrated in FIGS. 3 to 6, the high-frequency characters which are frequently selected are arranged in the central portions of respective key input areas, and a high-frequency character and a middle-frequency character arranged in the same key input area are arranged in the shape of character images haying similarity therebetween, thus allowing the user to easily memorize or associate the characters located in respective key input areas.

In this case, because lines corresponding to respective drag directions are present in characters that are input through a drag, the lines covered with arrows are formed as images, thus allowing the user to easily guess the positions of the characters and the drag directions thereof. That is, in order for the user to easily associate the characters with drag directions thereof, images of directions of arrows may be displayed to be overlaid with the characters.

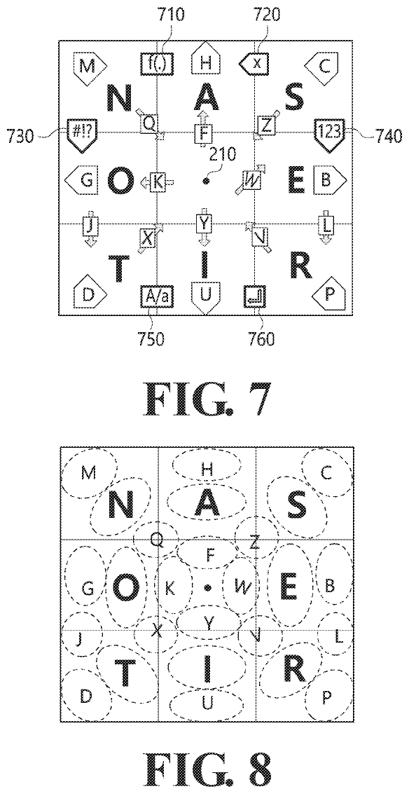

Further, referring to FIG. 7, a specific key 710 for switching a mode to a continuous drag mode may be input through a drag in the direction from the English character ‘N’ to the English character ‘A’ or in the opposite direction. A special key 720 for deleting one character may be input through a drag in the direction from the English character ‘S’ to the English character ‘A’. A special key 730 for inputting symbols may be input through a drag in the direction from the English character ‘N’ to the English character ‘O’. A special key 740 for inputting numbers may be input through a drag in the direction from the English character ‘S’ to the English character ‘E’. A special key 760 for a line break may be input through a drag in the direction from the English character ‘R’ to the English character ‘I’ or in the opposite direction. A special key 750 for switching between uppercase and lowercase letters may be input through a drag in the direction from the English character ‘T’ to English character ‘I’ or in the opposite direction.

Further, as illustrated in FIG. 11, the arrangement of all characters may be changed using a scheme for arranging a character 1110 that can be input through a touch, instead of a function key, in the central portion of the input screen. That is, the character key 1110 may be utilized such that, after a lowercase letter ‘i’ is arranged in the central key area of the input screen, when it is touched once, an uppercase letter ‘I’ may be input, when it is double-touched, ‘j’ may be input, and when it is touched and held for a predetermined time, microphone input associated with the lowercase letter ‘i’ is activated, and then a voice recording function is provided. Further, a special key 1130 for inputting a period and a special key 1140 for spacing (i.e., inputting a space or a space character) may be displayed as left and right drag areas, and drag methods corresponding to the association of images may be provided together with the keys.

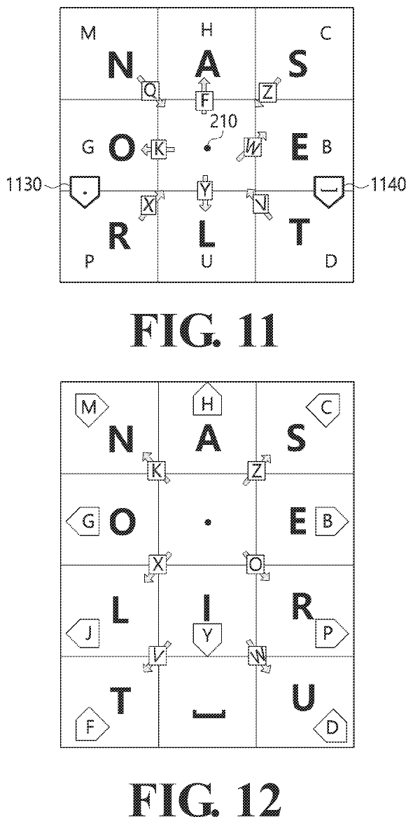

Further, referring to FIG. 12, an input screen according to the present invention may be extended to a 4×3 shape and used. In this case, since the number of key input areas is increased from that of the input screen having a 3×3 shape, the input screen may be arranged to have a large size so that ‘U’ and ‘L’, which are the middle-frequency characters, can each be input through a single touch.

That is, each of five vowels in the English alphabet may be arranged in a key input area in which the corresponding vowel can be input through a single touch, thus enabling association with the corresponding vowel to be easily performed. Although not a character, a spacing function or a period that is frequently used may be assigned to a touch key area and used.

In this case, even on the 4×3 input screen illustrated in FIG. 12, characters assigned to the same key input area may be arranged as characters easily associated with each other through images in order for the user to easily memorize the positions of the characters.

Here, on the input screen illustrated in FIG. 12, a basic drag may be a drag deviating from the current key input area to the outside of the current key input area.

For example, ‘Y’ may be input through a drag performed in a downward direction from ‘I’ while crossing the boundary of the key input area of ‘I’. The remaining low-frequency characters, that is, ‘K’, ‘Z’, ‘X’, ‘Q’, and ‘W’, may be arranged at points at which two boundary lines meet, and may be input when the corresponding key input areas are dragged in the direction of arrows to cross the boundary lines.

In this case, although not illustrated in FIG. 12, special keys or function keys may be arranged using empty spaces in which characters are not arranged.

Next, the text input method for improving speech recognition performance according to the embodiment of the present invention inputs characters through touch-based input depending on the input schemes at step S130.

Here, a function key may provide multiple functions, including spacing (input of a space or a space character), the input of a period, and voice recording, depending on the input schemes.

For example, in order to successively input characters, when the function key is touched once, one space is input, and when the function key is double-touched, a period may be input. Further, When the function key is touched and held for a predetermined time (i.e., long-pressed), a voice recording function may be provided such that an input word can be quickly recorded. That is, the present invention may simultaneously input text and voice using the function key to improve speech recognition performance.

Here, each high-frequency character may be input through a touch, each middle-frequency character may be input through any one of a double touch and a drag to the outside of a key input area, and each low-frequency character may be input through a drag to the boundary of a central key input area, among the multiple key input areas.

Here, when a continuous drag mode is selected through the function key, multiple characters that are successively selected in consideration of the start position of a drag, the end position of a drag, the point at which the direction of a drag changes, and a drag and hold point may be input.

Generally, because text input is slower than speech recognition, the is present invention proposes the continuous drag mode so as to support an input operation faster than existing touch input.

For example, in FIG. 7, when a function symbol f (.) 710 is dragged to cross a boundary between multiple key input areas and is input so as to set the continuous drag mode, a current input mode may switch to an input mode in which a continuous drag can be performed, as shown in FIG. 8. Here, FIG. 8 illustrates a display page shown as the result of switching to the continuous drag mode on a touch screen, and shows regions influencing characters to be input through a continuous drag.

Here, circles may be basically assigned as displayed character regions, and may be adjusted such that frequently used characters are more conveniently selected through a drag by differently setting the sizes of the circles depending on the usage frequency of characters.

A rule based on which characters are selected in the continuous drag mode is described below. First, characters corresponding to the start position of a drag and the end position of a drag are basically selected, and characters in regions through which the drag passes in the form of a straight line or a curve are not selected. Also, characters at points at which the direction of a drag changes or characters at drag and hold points corresponding to points which are dragged and held for a predetermined time are selected. In this case, after the drag is finished, a space may be automatically input.

When the function key ‘●’ is touched, a period may be input, when the function key ‘●’ is double-touched, the continuous drag mode may be terminated, and when the function key ‘●’ is touched and held for a predetermined time, a voice recording function may be selected.

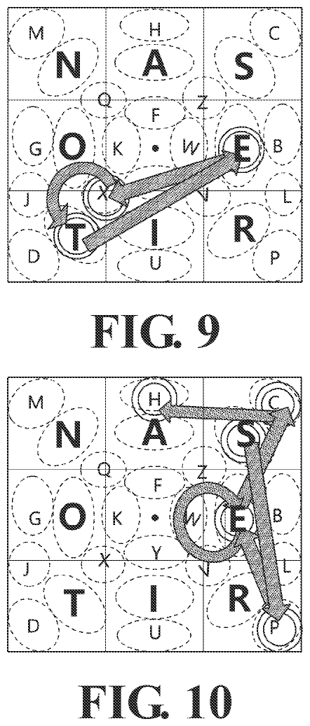

In this way, when the continuous drag mode is used, a word can be quickly input, as illustrated in FIGS. 9 and 10.

For example, FIG. 9 illustrates an example in which the word “TEXT” is input in the continuous drag mode, and FIG. 10 illustrates an example in which the word “SPEECH” is input in the continuous drag mode.

First, referring to FIG. 9, it can be seen that, in order to input the word “TEXT”, characters corresponding to ‘T’, ‘E’, ‘X’, and ‘T’ are sequentially selected. Referring to FIG. 10, it can be seen that, in order to input the word ‘SPEECH’, characters corresponding to ‘S’, ‘P’, ‘E’, ‘E’, ‘C’, and ‘H’ are sequentially selected. Here, the same character may be successively input by again selecting the corresponding character through a circular drag, as in the case of ‘E’ illustrated in FIG. 10.

Referring to FIGS. 9 and 10, whenever a character is selected in the continuous drag mode, the selected character is displayed and emphasized in a specific color, a circular pattern, or the like, thus providing input clarity to the user.

Here, the regions for the continuous drag mode according to the present invention are not limited to the example illustrated in FIG. 8, and various function key areas, not illustrated in FIG. 8, may be added.

Here, when the function key ‘ [symbol] ’ located in the central portion is dragged during continuous drag input, one space is input, and thus not only a word but also a sentence may be input through a single continuous drag action.

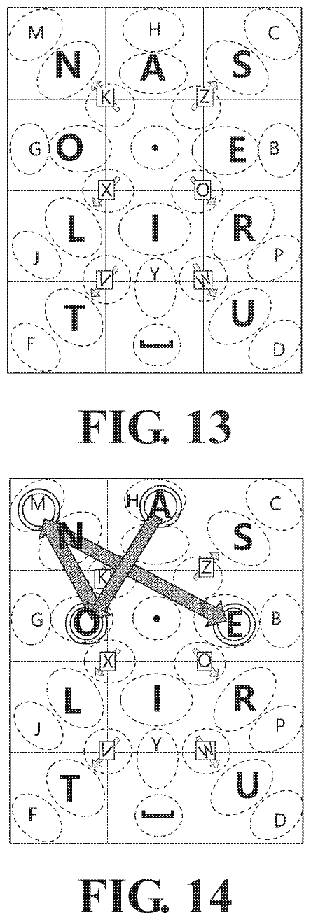

Further, as illustrated in FIGS. 13 to 15, characters may be successively input using the continuous drag mode, even on an input screen having a 4×3 shape,

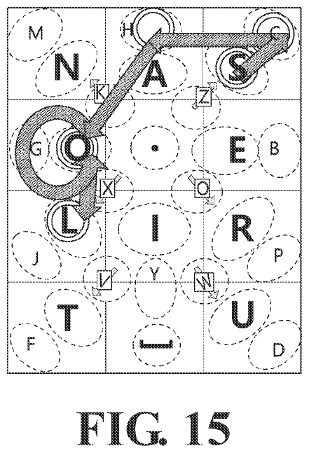

For example, FIG. 13 illustrates a display page shown as the result of switching to a continuous drag mode on a 4×3 touch screen, and shows regions influencing characters to be input through a continuous drag. FIG. 14 illustrates an example in which the word ‘HOME’ is input in the continuous drag mode based on a 4×3 touch screen, and FIG. 15 illustrates an example in which the word ‘SCHOOL’ is input in the continuous drag mode based on a 4×3 touch screen.

First, referring to FIG. 14, it can be seen that, in order to input the word ‘HOME’, characters corresponding to ‘H’, ‘O’, ‘M’, and ‘E’ are sequentially selected. Referring to FIG. 15, it can be seen that, in order to input the word ‘SCHOOL’, characters corresponding to ‘S’, ‘C’, ‘O’, ‘O’, and ‘L’ are sequentially selected. Here, the same character may be successively input by again selecting the corresponding character through a circular drag, as in the case of ‘O’ illustrated in FIG. 15. Thereafter, when the drag is finished, one space may be automatically input, after which the continuous drag mode may be executed again, and a subsequent word may be input through a continuous drag. Next, when the continuous drag mode is terminated by touching the function key ‘●’ located in the central portion or by double-touching the function key ‘●’, a period may be input.

Further, although not illustrated in FIG. 1, the text input method for improving speech recognition performance according to the embodiment of the present invention provides a voice recording function for recording voice corresponding to a word composed of input characters when voice recording is selected through the function key.

In this case, the word composed of input characters and voice data, corresponding to the word, recorded through the voice recording function may be provided to a speech recognition system.

Further, in the present invention, drag input is operated on a touch screen, but it is not limited to the touch screen. For example, drag input performed to cross the boundary between key input areas may be replaced with button input of quickly and successively pressing two key areas on a push-button-type input device. Furthermore, drag input moving to the outside of a key input area may be replaced with button input of quickly pressing a button twice on the push-button-type input device.

Although, in the above-described examples, a description has been made based on English text, the present invention may be applied to various languages, without being limited to English text.

In this way, by means of the text input method for improving speech recognition performance. English text, which is the most widely used language in the world, can be effectively input using a mobile device having a limited input area, such as a smartphone.

Further, character input may be divided into a touch and a drag depending on the usage frequency of characters, and the characters may be separately input through corresponding schemes, and thus accuracy and usefulness of input can be improved using only 3×3 key input areas, which can be relatively easily identified.

In addition, characters are arranged in the form of bundles of characters associated with each other through images, and the positions of characters to be dragged and the drag directions thereof are represented together by images, thus allowing the user to easily memorize the positions of the characters.

Furthermore, characters may be input through a single touch or a single drag, and thus the amount of motion required for text input may be minimized.

Furthermore, a continuous drag input mode may be provided, and thus words can be quickly input through a continuous drag.

Furthermore, after a character is input, a voice recording function is is provided using a hold function through a central function key in order to input a proper noun or correct error in a speech recognizer, thus contributing to the improvement of speech recognition performance.

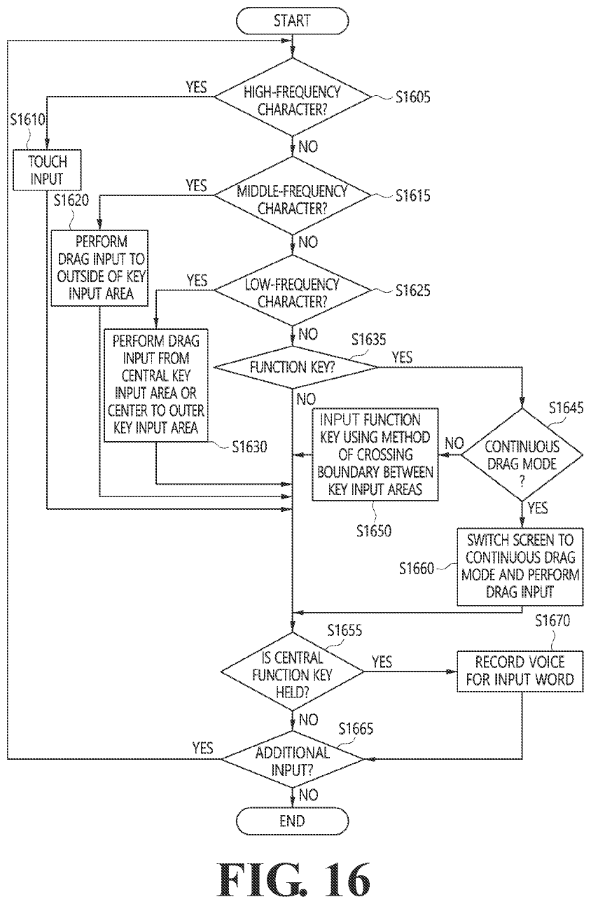

FIG. 16 is an operation flowchart illustrating a text input process according to an embodiment of the present invention.

Referring to FIG. 16, the text input process according to the embodiment of the present invention first determines whether a character selected by a user is a high-frequency character at step S1605. If it is determined that the selected character is a high-frequency character, the selected character may be input through touch input at step S1610.

If it is determined at step S1605 that the selected character is not a high-frequency character, whether the selected character is a middle-frequency character is determined at step S1615. If it is determined that the selected character is a middle-frequency character, the character may be input through a drag to the outside of a key input area or a double touch at step S1620.

If it is determined at step S1615 that the selected character is not a middle-frequency character, whether the selected character is a low-frequency character is determined at step S1625. If it is determined that the selected character is a low-frequency character, the character may be input through a drag to a central key input area while crossing the boundary of the central key input area or a drag from the central key input area to an outer key input area while crossing the boundary of the outer key input area at step S1630.

If it is determined at step S1625 that the selected character is not a low-frequency character, whether a function key is selected may be determined at step S1635.

If it is determined at step S1635 that a function key is selected, whether the current mode is a continuous drag mode is determined at step S1645. If it is determined that the continuous drag mode is selected, the screen switches to the continuous drag mode, thus enabling characters to be input in the continuous drag mode at step S1660.

Here, the continuous drag mode may be terminated by double-touching a central function key ‘●’.

Next, if it is determined at step S1645 that a continuous drag mode is not selected, it may be determined that a function key is input using a method of crossing the boundary between key input areas, and an input operation matching the corresponding input method may be performed at step S1650.

Thereafter, whether the central function key ‘●’ is touched and held for a predetermined time (i.e., long-pressed) may be determined at step S1655.

Further, at step S1655, whether the central function key ‘●’ is touched and held for a predetermined time may be performed even after steps S1610, S1620, and S1630.

Further, if it is determined at step S1655 that the central function key ‘●’ is touched and held for a predetermined time, a voice recording mode may be provided by activating a microphone to record voice corresponding to an input word or sentence at step S1670.

Here, when the touch and hold is released, the voice recording mode may be terminated.

Thereafter, whether additional input has occurred is determined at step S1665. If it is determined that additional input has occurred, the procedure from step S1605 may be repeatedly performed.

In contrast, if it is determined at step S1665 that additional input has not occurred, the text input may be terminated.

Here, in the present invention, various function keys, such as for language conversion, may be required. Therefore, the present invention may extend various function keys in various manners, and may provide the extended function keys.

By inputting text through the above-described method, input error that occurs due to the reduction of the sizes of input keys attributable to the spatial constraints of an input screen may be minimized, and characters may be efficiently input using only a small number of key input areas.

Further, the number of operations for inputting text can be reduced owing to a convenient text input stage, and the size of motion required for text input may be reduced, thus mitigating fatigue felt by the user.

Furthermore, because an input method is intuitive, the user's effort to learn the input screen so as to input text may be reduced, whereby usefulness of the text input method may be improved.

Furthermore, a voice recording function is provided, thus improving speech recognition performance for the user on a mobile device.

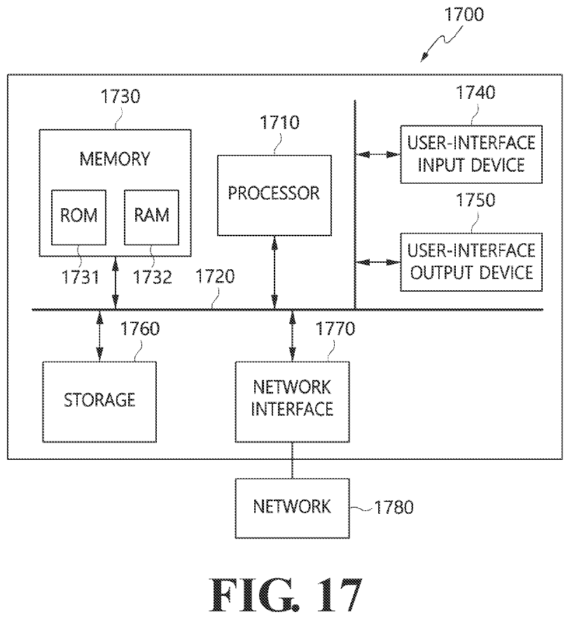

FIG. 17 is a diagram illustrating a text input apparatus for improving speech recognition performance according to an embodiment of the present invention.

Referring to FIG. 17, the text input apparatus for improving speech recognition performance according to the embodiment of the present invention may be implemented in a computer system such as a computer-readable storage medium. As illustrated in FIG. 17, a computer system 1700 may include one or more processors 1710, memory 1730, a user interface input device 1740, a user interface output device 1750, and storage 1760, which communicate with each other through a bus 1720. The computer system 1700 may further include a network interface 1770 connected to a network 1780. Each processor 1710 may be a Central Processing Unit (CPU) or a semiconductor device for executing processing instructions stored in the memory 1730 or the storage 1760. Each of the memory 1730 and the storage 1760 may be any of various types of volatile or nonvolatile storage media. For example, the memory 1730 may include Read-Only Memory (ROM) 1731 or Random Access Memory (RAM) 1732.

Accordingly, an embodiment of the present invention may be implemented as a non-transitory computer-readable storage medium in which methods implemented using a computer or instructions executable in a computer are recorded. When the computer-readable instructions are executed by the processor, the computer-readable instructions may perform a method according to at least one aspect of the present invention.

The processor 1710 arranges all characters on an input screen composed of multiple key input areas in consideration of usage frequencies for respective characters and usage association between characters.

Here, the multiple key input areas may be 3×3 or 3×4 key input areas, and a function key may be included in a central portion of the input screen.

Further, the processor 1710 may set respective input schemes for all characters in consideration of the positions of the multiple key input areas and the positions of characters arranged in each key input area.

Each of the input schemes may be set to correspond to any one of a touch, a double touch, a drag, and a hold.

In this case, arrows for guiding respective input schemes for all the characters to the user depending on the corresponding input schemes may be displayed together with the characters.

Here, the function key may provide multiple functions, including spacing, the input of a period, and voice recording, depending on the input schemes.

Here, a continuous drag mode can be provided in which multiple selected characters may be successively input in consideration of the start position of a drag, the end position of a drag, the point at which the direction of a drag changes, and a drag and hold point.

In this case, when voice recording is selected through the function key, a function of recording voice corresponding to a word composed of input characters may be provided.

In this case, the word composed of input characters and voice data, corresponding to the word, recorded through the voice recording function may be provided to a speech recognition system.

Further, the processor 1710 may input characters using touch-based input corresponding to the input schemes.

Here, all characters may be classified into low-frequency characters, middle-frequency characters, and high-frequency characters depending on the usage frequency of the characters, wherein each high-frequency character may be input through a touch, each middle-frequency character may be input through any one of a double touch and a drag to the outside of a key input area, and each low-frequency character may be input through a drag to the boundary of a central key input area, among the multiple key input areas.

Here, the high-frequency characters may be displayed on the input screen so as to appear larger than the middle-frequency characters and the low-frequency characters.

The memory 1730 stores the input schemes that are set for all characters.

In an embodiment, the memory 1730 may be implemented independently of the text input apparatus, and may then support touch-screen-based text input function for improving speech recognition performance. Here, the memory 1730 may function as separate large-capacity storage, or may include a control function for performing operations.

Meanwhile, the text input apparatus may include memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, a storage device is a computer-readable recording medium. In different embodiments, the storage device may include, for example, a hard-disk device, an optical disk device, or any other kind of mass storage device.

By utilizing the text input apparatus for improving speech recognition performance, English text, which is the most widely used language in the world, can be effectively input using a mobile device having a limited input area, such as a smartphone.

Further, character input may be divided into a touch and a drag depending on the usage frequency of characters, and the characters may be separately input through corresponding schemes, and thus accuracy and usefulness of input can be improved using only 3×3 key input areas, which can be relatively easily identified.

In addition, characters are arranged in the form of bundles of characters associated with each other through images, and the positions of characters to be dragged and the drag directions thereof are represented together by images, thus allowing the user to easily memorize the positions of the characters.

Furthermore, characters may be input through a single touch or a single drag, and thus the amount of motion required for text input may be minimized.

Furthermore, a continuous drag input mode may be provided, and thus words can be quickly input through a continuous drag.

Furthermore, after a character is input, a voice recording function is provided using a hold function through a central function key in order to input a proper noun or correct error in a speech recognizer, thus contributing to the improvement of speech recognition performance.

According to the present invention, there can be provided a method for allowing a user to effectively and quickly input principal characters, the recognition rate of which is to be increased, using a touch screen in order to improve the performance of a speech recognizer in a mobile terminal.

Further, the present invention may provide a text input method, which can mitigate fatigue while improving the usefulness of the text input method by providing an intuitive input method in which the number of operations of inputting text or the size of a motion required for text input is reduced.

Furthermore, the present invention may provide a text input method in a mobile terminal, which enables all characters to be input using only a touch and a drag with one hand and allows voice recording to be performed immediately after the input of characters is terminated.

As described above, in the text input apparatus for improving speech recognition performance and the method using the text input apparatus according to the present invention, the configurations and schemes in the above-described embodiments are not limitedly applied, and some or all of the above embodiments can be selectively combined and configured so that various modifications are possible.

What is claimed is:

1. A text input method, comprising:
arranging all characters on an input screen including multiple key input areas in consideration of usage frequency of respective characters and usage association between the characters;
setting input schemes for all the characters in consideration of positions of the multiple key input areas and positions of characters arranged in each key input area; and
inputting characters through touch-based input corresponding to the input to schemes.

2. The text input method of claim 1, wherein the multiple key input areas are 3×3 or 3×4 key input areas, and a function key is included in a central portion of the input screen.

3. The text input method of claim 2, wherein each of the input schemes is set to correspond to any one of a touch, a double touch, a drag, and a hold.

4. The text input method of claim 3, wherein the function key provides multiple functions including spacing, input of a period, and voice recording, depending on the input schemes.

5. The text input method of claim 3, wherein all the characters are classified into a low-frequency character, a middle-frequency character, and a high-frequency character depending on the usage frequency, wherein the high-frequency character is input through a touch, the middle-frequency character is input through any one of a double touch and a drag to outside of a key input area, and the low-frequency character is input through a drag to a boundary of a central key input area, among the multiple key input areas.

6. The text input method of claim 5, wherein the high-frequency character is displayed on the input screen to appear larger than the middle-frequency character and the low-frequency character.

7. The text input method of claim 3, wherein arrows for guiding respective input schemes for all the characters depending on the corresponding input schemes are displayed together with the characters.

8. The text input method of claim 4, wherein inputting the characters is configured to provide a continuous drag mode in which successively selected multiple characters are input in consideration of a start position of a drag, an end position of a drag, a point at which a direction of a drag changes, and a drag and hold point.

9. The text input method of claim 4, further comprising:
when voice recording is selected using the function key, providing a voice recording function of recording voice corresponding to a word including input characters.

10. The text input method of claim 9, further comprising:
providing the word including the input characters and voice data, corresponding to the word, recorded through the voice recording function to a speech recognition system.

11. A text input apparatus, comprising:
a processor for arranging all characters on an input screen including multiple key input areas in consideration of usage frequency of respective characters and usage association between the characters, setting input schemes for all the characters in consideration of positions of the multiple key input areas and positions of characters arranged in each key input area, and inputting characters through touch-based input corresponding to the input schemes; and
a memory for storing respective input schemes that are set for all the characters.

12. The text input apparatus of claim 11, wherein the multiple key input areas are 3×3 or 3×4 key input areas, and a function key is included in a central portion of the input screen.

13. The text input apparatus of claim 12, wherein each of the input schemes is set to correspond to any one of a touch, a double touch, a drag, and a hold.

14. The text input apparatus of claim 13, wherein the function key provides multiple functions including spacing, input of a period, and voice recording, depending on the input schemes.

15. The text input apparatus of claim 13, wherein all the characters are classified into a low-frequency character, a middle-frequency character, and a high-frequency character depending on the usage frequency, wherein the high-frequency character is input through a touch, the middle-frequency character is input through any one of a double touch and a drag to outside of a key input area, and the low-frequency character its is input through a drag to a boundary of a central key input area, among the multiple key input areas.

16. The text input apparatus of claim 15, wherein the high-frequency character is displayed on the input screen to appear larger than the middle-frequency character and the low-frequency character.

17. The text input apparatus of claim 13, wherein arrows for guiding respective input schemes for all the characters depending on the corresponding input schemes are displayed together with the characters.

18. The text input apparatus of claim 14, wherein the processor is configured to provide a continuous drag mode in which successively selected multiple characters are input in consideration of a start position of a drag, an end position of a drag, a point at which a direction of a drag changes, and a drag and hold point.

19. The text input apparatus of claim 14, wherein the processor is configured to, when voice recording is selected using the function key, provide a voice recording function of recording voice corresponding to a word including input characters.

20. The text input apparatus of claim 19, wherein the processor is configured to provide the word including the input characters and voice data, corresponding to the word, recorded through the voice recording function to a speech recognition system.
